(19) United States
(12) Patent Application Publication
(10) Pub. No.: US 2013/0036861 A1
(43) Pub. Date: Feb. 14, 2013

(54) INERTIA AUGMENTED SUPER BOOST ACCELERATION IN HIGH PERFORMANCE CRANK SHAFTS

(71) Applicant: ATAUL HAQ, Port Saint Lucie, FL (US)

(72) Inventor: ATAUL HAQ, Port Saint Lucie, FL (US)

(21) Appl. No.: 13/570,245

(22) Filed: Aug. 9, 2012

Related U.S. Application Data
(60) Provisional application No. 61/521,856, filed on Aug. 10, 2011.

(51) Int. Cl. H02K 7/02

(52) U.S. Cl. 74/572.11

(57) ABSTRACT

This invention is a Method and apparatus for converting centrifugal energy stored during normal rotation of a crank shaft or fly wheel, to a sudden angular acceleration, which is useful to attain sudden boost in speed, especially in high performance racing automotives. This phenomenon is achieved by converting centrifdgal energy stored in certain controlled floating weights inside tubular cavities machined into the arms of crank shaft or in the flywheels in such a manner that certain fluid pressure activated through controlled valves exerts pressure which moves the weights towards the center of the axis of rotation, thereby creating sudden angular acceleration of the crank shaft. This conversion of centrifugal energy, which is stored in certain elements during normal rotation of crank shaft or flywheel is harnessed when it is absolutely needed, such as during the end of a victory lap of a racing automotive.

Prior Application Provisional Application No. US 61/521,856
Filling Date Aug. 10, 2011

General Field of Invention Automotive

### CROSS-REFERENCE TO RELATED APPLICATIONS

### US Patents Documents

U.S. Pat. No. 6,614,132 B2 Hockney et al
U.S. Pat. No. 7,533,639 B1 Berger et al
U.S. Pat. No. 6,675,759
U.S. Pat. No. 4,688,528
U.S. Pat. No. 6,453,864 B1 Downs et al
U.S. Pat. No. 2,255,773 A Heftler

### Field of Classification Search

123/59.6, 123/192.1, 307/42

### U.S. Classification

123/59.6, 123/192.1, 307/42
   Int. Cl.
F02B 75/20, F02B 75/06

### STATEMENT REGARDING FEDERALLY SPONSORED RESEARCH OR DEVELOPMENT

“Not Applicable”

### BACKGROUND OF THE INVENTION

### Field of the invention

This invention relates to high performance automotive engines, typically a sports car. A sudden acceleration is achieved by moving a free floating weight towards the axis of rotation of a crank shaft or a flywheel, converting the centrifugal energy into angular acceleration. The same arrangement can be utilized to help slow down the engine thereby assisting the braking system of high performance engines. This phenomenon is achieved by providing free floating weights inside a certain flywheel or crank shaft in such a way that these weights assisted by certain spring floats outward from the axis of rotation due to centrifugal force, inside a hollow member. Certain motive force such as hydraulic fluid pressure, magnetic flux etc. moves these weights towards the center of the axis of the rotation thereby transferring the centrifugal energy into a torque. Such hydraulic pressure can be achieved by simply providing a valve that can control the pressure of fluid such as lubricating oil to move the weights towards or away from the axis of rotation, through capillaries provided at the end of the hollow tubes in which these weights are floating free on certain springs that are provided at the each end of the hollow tube.

Description of related art, including informational disclosure under CFR 1.97 and CFR 1.98

### BRIEF SUMMARY OF THE INVENTION

This invention pertains to a sudden boost to the angular speed of a certain high performance engines by converting centrifugal energy stored in certain controlled floating bodies during rotation of certain members, like crank shaft or flywheel. This phenomenon is achieved by moving free floating weights towards or away from the center of the axis of rotation of a crank shaft or a fly wheel.

Hollowed arms of certain crank shaft carries certain floating weight capable of moving freely along its length, these weights are held at a certain position by certain coil spring and hydraulic pressure. These free weight can be moved to certain position in the hollow portion of each arm by certain force such as electro-magnetic flux, hydraulic pressure, spring force etc.

Capillary tubes are drilled or made in certain way that at the actuation of a certain valve, forces hydraulic fluid (such as engine oil) into the capillaries which are terminated at the fixed axis of the rotating crank shaft or the fly wheel. The fluid forces the weights in each hollow arm to move outward or inward toward the axis thereby achieving certain sudden angular acceleration or angular deceleration of the rotating crank shaft or flywheel.

### BRIEF DESCRIPTION OF THE DRAWINGS

FIG. 1 is a isometric view of a typical crank shaft and a attached fly wheel.

FIG. 2 is the cross section of the flywheel, showing the inventive elements and mechanisms. The free floating weights, springs and fluid capillaries are shown.

FIG. 3 is schematics of the inventive embodiment, showing the operation of the free weight and valves controlling the hydraulic fluid pressure in order to move the free floating weights inside hollow members of crank shaft or fly wheel.

### DETAIL DESCRIPTION OF THE INVENTION

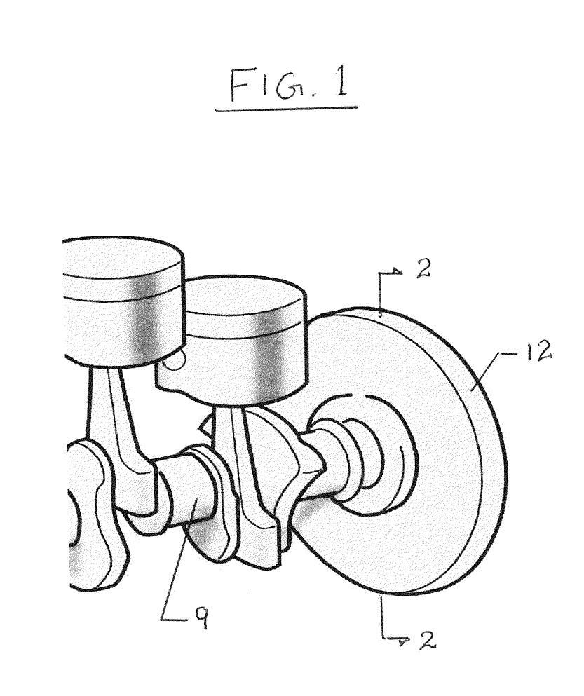

An isometric view of a typical crank shaft (9) with fly wheel (12) is shown in FIG. 1. Counter weight (1) and flywheel (12) have hollow cavities (2) which houses free floating weights (3) suspended at a certain position due to centrifugal forces and springs (4). These free floating weights moves outward away from the axis of crank shaft due to centrifugal force generated due to the rotation of the crank shaft. These weights, thereby, stores a huge amount of energy at a particular radial distance from the axis of the rotating shaft. A hydraulic pressure or an electro-magnetic force is applied through certain mechanism to move these weights towards or away from the center of the axis during rotation, thereby transferring huge amount of the centrifugal energy to the angular acceleration or vice versa for deceleration.

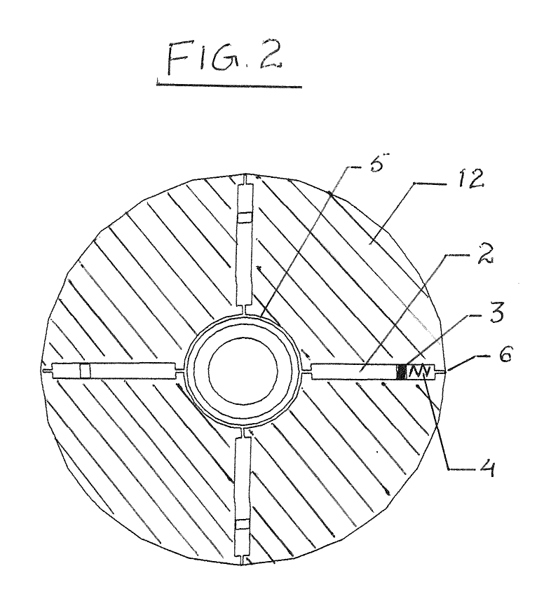

FIG. 2 is a cross section of the flywheel (12) perpendicular to the shaft axis. Tubular cavities (2) spaced radialy, housed certain free floating weights (3) along with coil springs (4) at each end. Capillary (6) delivers pressurized fluid to push the weight (3) towards the center of the axis of rotation, thereby causing sudden boost in angular acceleration of the shaft. Capillary (5) is located at the lower end of the tubular cavity (2) and can be used to move certain weight (3) away from the axis of the shaft in order to decelerate the angular speed of the shaft.

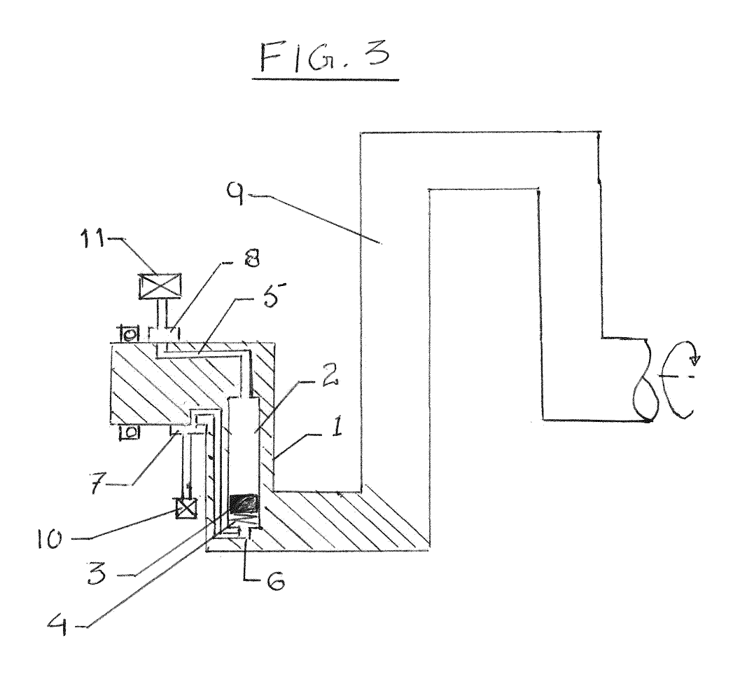

FIG. 3 is a cross section of a typical crank shaft (9) at one of its arm (1) of the counter weight or the crank connecting to the connecting rod. A hollow cavity (2) contains a free floating weight (3) and springs (4) at its each end. Capillary (6) which starts at the outer end of cavity (2), terminates at a pressure chamber (7) on the crank shaft (9). Capillary (5) which starts at the lower end of the cavity (2), terminates at pressure chamber (8) on the crank shaft (9). The fluid pressure is controlled by valves (10) and (11).

The disclosed embodiment of the apparatus, system and method according to the invention are illustrative of the scope of the invention, which is recited in the following claims. Various modifications of the disclosed embodiments can be made or are apparent from the description contained herein, without departing from the scope of the invention is claimed.

The invention claimed is:

1. A mechanical arrangement to provide movement of a certain free weight floating inside of a certain tubular cavity perpendicular to the axis of rotation of a certain rotating member or body of a rotating assembly, crank shaft or flywheel, towards or away from the axis of its rotation by means of certain force exerted on the free weight or at the either end of such free weight.

2. The embodiment according to claim 1, has certain hollow tubular cavity inside of each of its rotating member or arm or the entire body spaced radialy along the entire rotating member perpendicular to its axis of rotation.

3. The embodiment according to claim 1, has solid weight freely moveable inside these tubular cavities along its entire length and having certain coil spring provided at either end of these free weights inside these hollow tubular cavities.

4. The embodiment according to claim 1 has capillaries provided at the each end of certain tubular cavity which can deliver certain fluid in order to exert pressure on the free floating weight in order to move the weight towards or away from the axis of rotation.
